(19) United States
(12) Patent Application Publication
(10) Pub. No.: US 2012/0150584 A1
(43) Pub. Date: Jun. 14, 2012

(54) DESIGN OF WARRANTY BONUSES FOR PRODUCTS

(76) Inventors: Filippo Balestrieri, Mountain View, CA (US); Julie Ward Drew, Redwood City, CA (US)

(21) Appl. No.: 12/968,011

(22) Filed: Dec. 14, 2010

(51) Int. Cl. G06Q 10/00; G06Q 30/00

(52) U.S. Cl. 705/7.31

(57) ABSTRACT

Systems, methods, and computer-readable and executable instructions are provided for designing warranty bonuses. Designing warranty bonuses can include determining, for a customer base of a product, a first probability that a customer will replace the product with a different product. Designing warranty bonuses may also include determining, for the customer base, a marginal contribution to the first probability for a plurality of warranty bonus sizes and a plurality of warranty bonus types. Designing warranty bonus can include determining, for the customer base, a second probability that the customer will purchase a warranty for the plurality of warranty bonus sizes and the plurality of warranty bonus types. Designing warranty bonuses may also include bundling the product and the warranty, and assigning a number of the plurality of warranty bonus sizes and a number of the plurality of warranty bonus types to the product-warranty bundle based on the first and second probabilities and the marginal contribution.

### BACKGROUND

Warranties offer an opportunity of a connection between a product manufacturer or seller and the customer beyond the moment of purchase. This is particularly true when the warranties have associated bonuses paid to the customer. When a product's warranty contract expires or is terminated by a customer, there is an increased possibility the customer will replace the product. This period of time represents an opportunity for the warranty provider or seller to approach the customer with attractive product offerings. If the customer chooses a product from a different seller, it may be difficult to win back the customer's business.

Warranties with a bonus paid to the customer can be used to enhance the seller's post-purchase connection to the customer. An example of a bonus warranty is a refundable bonus warranty which may entitle the customer to receive a pro-rated refund when they terminate the warranty coverage prior to the end of the term. Another example of a warranty with a bonus is a residual value warranty that may pay the customer a partial refund of the upfront price at the end of the warranty term depending on their claim history. Bonus warranties may be differentiated into those with cash refunds and those that result in money spendable only on products sold by the seller or warranty provider.

The payment of a warranty bonus may stimulate demand for future purchases from the seller, depending on the nature of the bonus payment. Sellers are faced with the problem of determining which size and type of bonus, if any, to associate with a given product's warranty.

### BRIEF DESCRIPTION OF THE DRAWINGS

FIG. 1 is a flow chart illustrating an example of a method for designing warranty bonuses according to the present disclosure.

FIG. 2 illustrates a diagram of an example of a system for designing warranty bonuses according to the present disclosure.

FIG. 3 illustrates a block diagram of an example of a computing system for designing warranty bonuses according to the present disclosure.

### DETAILED DESCRIPTION

Embodiments of the present disclosure may include methods, systems, and computer-readable and executable instructions and/or logic. An example method for designing warranty bonuses may can include determining, for a customer base of a product, a first probability that a customer will replace the product with a different product. The method may also include determining, for the customer base, a marginal contribution to the first probability for a plurality of warranty bonus sizes and a plurality of warranty bonus types. The method can include determining, for the customer base, a second probability that the customer will purchase a warranty for the plurality of warranty bonus sizes and the plurality of warranty bonus types. The method may also include bundling the product and the warranty, and assigning a number of the plurality of warranty bonus sizes and a number of the plurality of warranty bonus types to the product-warranty bundle based on the first and second probabilities and the marginal contribution.

In the following detailed description of the present disclosure, reference is made to the accompanying drawings that form a part hereof, and in which is shown by way of illustration how examples of the disclosure may be practiced. These examples are described in sufficient detail to enable those of ordinary skill in the art to practice the embodiments of this disclosure, and it is to be understood that other examples may be utilized and that process, electrical, and/or structural changes may be made without departing from the scope of the present disclosure.

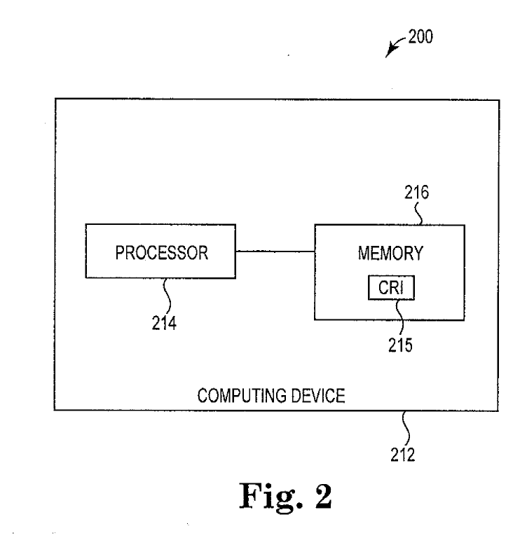

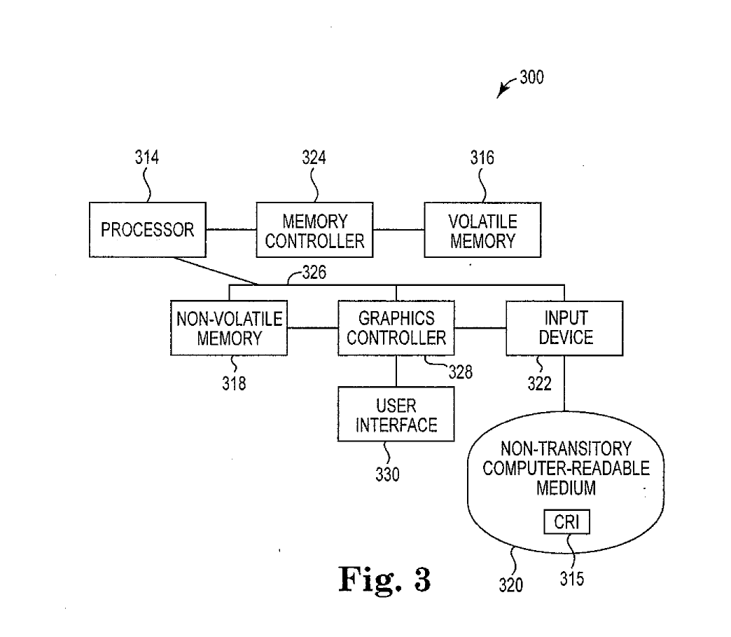

The figures herein follow a numbering convention in which the first digit or digits correspond to the drawing figure number and the remaining digits identify an element or component in the drawing. Similar elements or components between different figures may be identified by the use of similar digits. For example, 214 may reference element “14” in FIG. 2, and a similar element may be referenced as 314 in FIG. 3. Elements shown in the various figures herein can be added, exchanged, and/or eliminated so as to provide a number of additional examples of the present disclosure. in addition, the proportion and the relative scale of the elements provided in the figures are intended to illustrate the examples of the present disclosure, and should not be taken in a limiting sense.

A warranty is an assurance that some product or service will be provided or will meet certain specifications. Warranties can be utilized to assist in the management of customer relationships or as a mechanism to retain customers. Warranties may take several forms. One type of warranty is a warranty that includes a bonus paid to the customer. There are many different types of bonus warranties. An example bonus warranty includes a refundable bonus warranty, in which the customer may be entitled to receive a pro-rated refund of the warranty premium when they terminate the warranty coverage prior to the end of the term. Another example of a warranty with a bonus is a residual value warranty that may pay the customer a partial refund of the warranty premium at the end of the warranty term depending on their claim history. Another example is a warranty with a bonus that is proportional to the price of the base product at the moment of purchase. The bonus may be larger than the warranty price.

The payment of a bonus can stimulate demand for future purchases from the seller, depending on the nature of the bonus payment. A seller or warranty provider has the task of choosing between multiple different warranty types, length/duration, and bonus types all while attempting to increase overall profits.

The bonuses themselves may come in many different forms, and the payment of a bonus may stimulate demand for future purchases from the warranty provider, depending on the nature of the bonus payment. Examples of warranty bonuses may include cash bonuses, checks, or coupons applicable toward a future purchase of a specific product or set of products. Warranty bonuses may be restrictive, which can result in higher customer retention. In an example restrictive bonus, the warranty provider may reward the customer with the warranty provider's own products or coupons applicable only to specific products sold by the warranty provider. These warranties and restrictive bonuses may be attractive to the warranty provider, but may not be as attractive to a customer as a flexible warranty bonus.

Warranty bonuses can also be flexible, which may result in decreased customer retention. An example of a flexible bonus is cash that the customer may spend on anything they choose. These bonuses may be attractive to customers and can lead to higher warranty sales, but they may not stimulate future demand for the warranty provider's products. Warranty bonuses may also be categorized somewhere between restrictive and flexible. It is important for a warranty provider to select a proper bonus to bundle with a given product's warranty to improve short- and long-term profits.

A bonus in a warranty may be used strategically to stimulate the sale of other products by a warranty provider that is also a multi-product seller. The warranty provider can set restrictions on how the warranty bonus can be spent by customers, and in that way, increase demand towards specific products or product categories. A bonus in a warranty may also be used strategically to stimulate the sale of products sold by a business partner of the warranty provider. Fewer restrictions on the bonus may make a warranty more valuable to the customers (and so its price can be higher), but more restrictions may result in higher customer retention rates and better control over future demand for specific products, A warranty may also be provided at no cost (eg., warranty price is zero) to a customer.

A strategic use of warranties with bonuses may allow the warranty provider to improve customer retention rates and increase demand towards high margin products when possible. Certain designs of warranty bonuses for products may allow the warranty provider to balance the trade-off between short-term profits and long-term profits on a product-by-product basis, where products may be considered differently if they appeal to different market segments (e.g., in terms of price sensitivity, attitude towards technology, brand loyalty, and other customer characteristics).

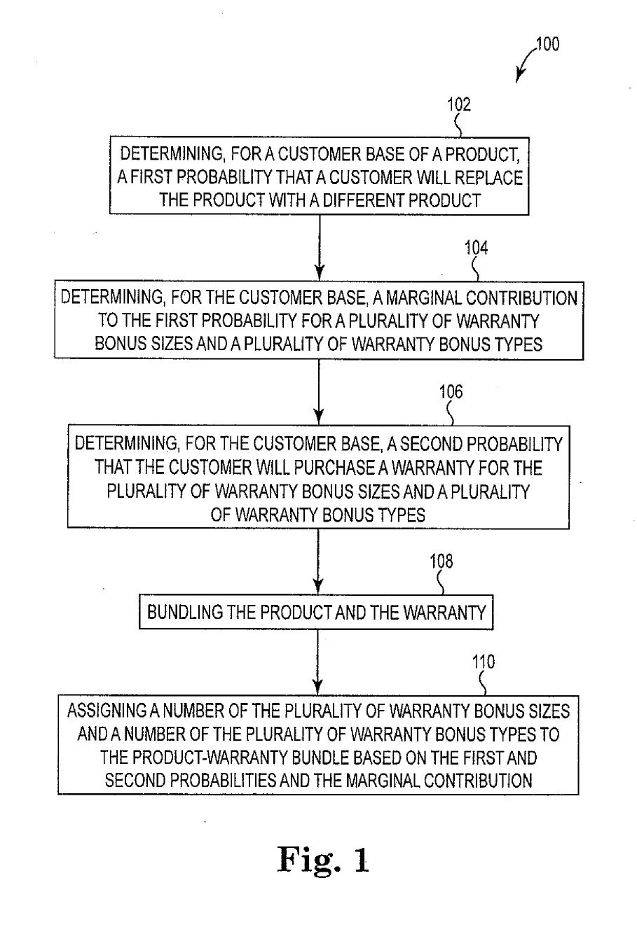

FIG. 1 is a flow chart illustrating an example of a method 100 for designing warranty bonuses according to the present disclosure. Each of the warranty provider's products is associated with a description of its customer base. The description of the customer base may come from the fact that the product was designed specifically for a segment of the population and from information dynamically collected through surveys or product registration data analysis. The product registration data analysis may include analyzing customers' ages and income, a product's purchase price, a date of purchase, a location of purchase, and factors that may have influenced the purchase (e.g., the product was on sale). The description of a product's customer base may include information regarding price sensitivity, attitudes towards technology (such as product replacement patterns), brand loyalty, and other characteristics.

At 102, a first probability that a customer will replace a product j with a different product is determined based on the customer base of product j. The warranty provider can estimate, for a given product's customer base, the likelihood that the customer will replace the product with each of several different product categories (e.g., high-end vs. low-end dishwasher) and at different times (1 year, 2 years, etc). In an example, Pⱼₖₗ(w) can be the probability that a customer of product j will replace it with a product in category k at time t when the customer received or purchased a warranty of length w, without any bonus. In an example, these probabilities can be calculated according a collaborative method that uses information about every customer that belongs to the customer base of a particular product.

At 104, a marginal contribution to the first probability for a plurality of warranty bonus sizes and a plurality of warranty bonus types is determined. In an example, a marginal contribution may be calculated through field experiments conducted regularly over time, and more than one marginal contribution may be determined. A marginal contribution may be the change (negative, positive, or none) in the first probability induced by an offer of a warranty bonus of a given size and type. In another example, Δⱼₖₗ(w,r,s) may be the incremental probability that a customer of product j will purchase a product in category k after time t, given that the customer received or purchased a warranty of length w with bonus type r and size s. This incremental probability may be negative. The estimation of the probabilities may be a dynamic process that goes through several updates as more data becomes available. This may be important with newer products, specifically when a customer base is not clearly identifiable, and it may not be clear who may be interested in buying the new product.

In an example of marginal contributions, if the bonus type r is a credit toward a future purchase of products in a specific category k, it may be that the incremental probability Δⱼₖₗ(w,r,s) of a purchase in the specific category k after a given time t would be higher than for a cash refund bonus.

At 106, a second probability that a customer who purchases the product j will purchase a warranty for the plurality of warranty bonus sizes and the plurality of warranty bonus types is determined. The warranty may be a base warranty or an extended warranty. A base warranty may be a contract provided free of charge by the warranty provider to cover the costs of services on the product. An extended warranty may be a contract that can be purchased to cover the costs of products or services beyond the warranty provider's original warranty period. An extended warranty may allow the customer to receive support and product repair services above and beyond what is provided by a standard warranty associated with the product. In an example, Qⱼₜ(r,s,q) may be the probability that a customer who has just purchased product j will purchase a warranty of duration t with refund type r and refund size s at price q. In an example of a base warranty, the price q may be zero. The first and second probabilities, as well as the marginal contribution, may be determined for a customer base of each of a plurality of products.

At 108, the product j may be bundled to the warranty. The warranty may be a base warranty or an extended warranty. In an example, the product j may be bundled to one or more warranty types.

At 110, a number of the plurality of warranty bonus sizes and a number of the plurality of warranty bonus types are assigned to the product-warranty bundle based on the first and second probabilities and the marginal contribution. In an example, multiple warranty bonus sizes and multiple warranty bonus types may be assigned to a product-warranty bundle. Each product-warranty bundle may be matched with a bonus that can result in a function of the short- and long-term profits meeting or exceeding a desired combination of short-term profits and long-term profits. The warranty provider's short-term profits may be linked to the warranty price level, and may be based on a function of the warranty price and probability of warranty purchase. The warranty provider's long-term profits may be based on a function of a probability of warranty purchase, a probability of repurchase, and expected margins on future sales of a plurality of products.

A threshold for total profit (e.g., a combination of short- and long-term profits may be received. An example total profit threshold may result in maximized overall profits, and another example threshold may include a specific dollar amount. These thresholds are non-limiting, and in some examples, a product-warranty bundle may be matched with the bonus size and type that ensures that a function of the short- and long-term profits reaches the highest overall threshold. The highest overall threshold may represent the maximum possible objective value of short- and long-term profits subject to applicable constraints. Analyzing a customer base rather than a single customer can allow for increased efficiency in determining which factors to use to meet or exceed a threshold and, in an example, maximize profits.

In an example, the warranty provider's profit objective may include a combination of immediate profits from the sale of warranties and long-term profits from future product sales. In an example, a relative weight a may be given to short-term warranty profits, with α being between 0 and 1, inclusive. A relative weight “1−α” may be given to long-term profits from product net sales, with 1−α a being 1 minus the relative weight of the short-term warranty profits. The relative weight of the short-term profits may be determined based on the importance of the short-term profits to the warranty provider. In an example, the relative weight may vary at different times depending on the warranty provider's current needs and objectives.

In an example, an approach to a warranty provider's profit objective is taken that includes considering all products simultaneously, so that the interdependencies (e.g., complementarities, substitutability, etc.) between a number of products are taken into account. The interdependencies between several bonuses may also be considered. This may result in increased profits over the use of an approach where the warranty provider uses warranty bonuses to maximize profits from the sale of a specific product and does not consider product interdependencies.

In an example of assigning warranty bonuses to warranty-product bundles, the warranties' characteristics (eg., price, duration, etc.) are considered. Different scenarios can be examined, where each scenario corresponds to a different combination of products and warranties. The warranties considered in different scenarios may differ in terms of their characteristics (e.g., introducing a new warranty with a shorter duration, increasing the prices of all warranties by 10 percent, etc.). In an example, for each scenario, a number of warranty bonuses may be assigned to the warranty-product bundles, and an estimate of the short-term and long-term profits may be obtainable.

Short-term warranty profits can be linked to a warranty price level and probability of warranty purchase, and long-term profits can be a function of a probability of warranty purchase, a probability of repurchase, and expected margins on future sales of a plurality of products. In an example, short- and long-term profits are not based solely on warranty sales. In an example, a warranty provider may see immediate profits by charging a higher price for a warranty with a cash bonus. The long-term profits may not be increased due to a customer spending the cash on a product not sold by the warranty-provider. In another example, long-term profits may be increased when a customer purchases a low-price warranty with a highly restrictive bonus requiring it is spent on only products sold by the warranty provider.

In an example, each product j has a predetermined warranty length w(j) and warranty price qⱼ. A warranty bonus type r and size s that may increase overall profits for the warranty provider may be determined using multiple variables including the predetermined warranty length and price. In an example, several warranties may be offered with one product.

A margin mₖ earned per product sold from category k and a support cost cⱼₜ for a warranty of a length t on product j may be used to determine the warranty bonus type and size that may increase overall profits for the warranty provider. A support cost can include the cost to the warranty provider to maintain and honor the warranty. In an example, a higher support cost reduces the warranty provider's long-term profits. Discrete possible refund types indexed by r=1, . . . , R and discrete possible refund sizes indexed by s=1, . . . ,S may also be variables used to determine the warranty bonus type and size. Refund types may include cash, checks, coupons to purchase a specific product, and coupons to purchase one of a plurality of products sold by the warranty provider. Refund sizes may vary from no refund to a high value refund.

In an example, decision variables and parameters may aid in determining a warranty bonus type and size. In an example, decision variable xⱼᵣₛmay be 1 if refund type rand refund size s are assigned to product j, and decision variable xⱼᵣₛ may be 0 otherwise. Furthering the example, decision variable xⱼᵣₛ may be expressed as a vector x=(xⱼᵣₛ). In an example, parameter yₖᵣ can be 1 if bonus type r can be applied to products in category k. Parameter yₖᵣ may be 0 if bonus type r cannot be applied to products in category k.

A function may be used to determine a warranty bonus type and size to pair with a product that can increase a warranty provider's profit objectives. In an example, the warranty provider's objective may be to maximize a function, Z(x)=αΣⱼΣₛΣᵣ(qⱼ−c_{jw(j))x}ⱼᵣₛQ_{jw(j)}(r, s, qⱼ) +(1−α)ΣⱼΣₖΣₜ[Pⱼₖₜ(w(j))mₖ+ΣₛΣᵣxⱼᵣₛ(Δⱼₖₜ(w(j),r, s)mₖ−syₖᵣ(Pⱼₖₜ(w(j))+(Δⱼₖₜ(r, s))], subject to the constraints Σᵣₛxⱼᵣₛ=1 for each product j. In an example, the problem can be decomposed into separate problems for each product. The values of the decision variables x=(xⱼᵣₛ) may be set to maximize the value of the objective function. in an example, the decision variables x=(xⱼᵣₛ) may be set in such a way that a threshold level T for Z(x) is reached or exceeded (e.g., Z(x)≧T). A summation operator over warranties w may be included to consider a case with multiple warranties offered with a given product.

In an example, a more general formulation may include interactions between the assignments of bonus types across products, such as a budget constraint on total bonus payouts (e.g., a warranty provider may only offer a limited number of warranty bonuses due to budget constraints), which may require a simultaneous solution across products. In an example, base warranties may be designed, and the price of the warranty is zero, so the short-term profit component may be ignored. A simultaneous solution may be used when considering products with interdependencies.

In a further example, a function is objective, flexible, and is adaptable to the warranty provider's purposes. In an example, the warranty provider may be risk averse for what concerns the present, but risk neutral for what concerns the future. The function may be concave in the present-related arguments and linear in the future-related arguments.

FIG. 2 illustrates a diagram of an example of a system for designing warranty bonuses according to the present disclosure. The system 200 can include a computing device 212 including a processor 214 coupled to a memory 216 (e.g., volatile memory and/or non-volatile memory). The memory 216 may include computer-readable instructions (e.g., software) 215 for designing warranty bonuses. In an example, the processor 214 coupled to the memory 216 may determine, for a customer base of a product, a first probability that a customer will replace a product with a different product in a specific category at a specific time when the customer receives a warranty of a specific length without a bonus. In an example, the processor 214 may also determine, for the customer base, a second probability that the customer will replace the product with the different product when the customer receives a warranty of a specific length with a bonus of a specific type and a specific size.

In an example, the processor 214 coupled to the memory 216 may determine, for the customer base, a marginal contribution to the first and second probabilities of each of a plurality of warranty bonus sizes and each of a plurality of warranty bonus types and determine, for the customer base, a third probability that the customer will purchase a warranty of a specific length with a specific refund type and a specific refund size at a specific price. The processor 214 may also bundle the product and the warranty and assign a number of the plurality of warranty bonus sizes and a number of the plurality of warranty bonus types to the product-warranty bundle based on a plurality of variables including the first, second, and third probabilities; the marginal contributions; a weight of short-term and long-term profits; a margin earned per product sold from the specific category; and a support cost for a warranty of a specific length on the product.

FIG. 3 illustrates a block diagram of an example of a computing system 300 for designing warranty bonuses according to the present disclosure. However, examples of the present disclosure are not limited to a particular computing system configuration. The system 300 can include processor resources 314 and memory resources (e.g., volatile memory 316 and/or non-volatile memory 318) for executing instructions stored in a tangible non-transitory medium (e.g., volatile memory 316, non-volatile memory 318, and/or computer-readable medium 320) and/or an application specific integrated circuit (ASIC) including logic configured to perform various examples of the present disclosure. A computer (e.g., a computing device) can include and/or receive a tangible non-transitory computer-readable medium 320 storing a set of computer-readable instructions (e.g., software) via an input device 322. As used herein, processor resources 314 can include one or a plurality of processors such as in a parallel processing system. Memory resources can include memory addressable by the processor resources 314 for execution of computer-readable instructions. The computer-readable medium 320 can include volatile and/or non-volatile memory such as random access memory (RAM), magnetic memory such as a hard disk, floppy disk, and/or tape memory, a solid state drive (SSD), flash memory, phase change memory, etc. In some examples, the non-volatile memory 318 can be a database including a plurality of physical non-volatile memory devices. In various examples, the database can be local to a particular system or remote (e.g., including a plurality of non-volatile memory devices 318). A computing device having processor resources can be in communication with, and/or receive a tangible non-transitory computer readable medium (CRM) 320 storing a set of computer readable instructions 315 (e.g., software) for designing warranty bonuses, as described herein.

The processor resources 314 can control the overall operation of the system 300. The processor resources 314 can be connected to a memory controller 324, which can read and/or write data from and/or to volatile memory 316 (e.g., RAM). The memory controller 324 can include an ASIC and/or a processor with its own memory resources (e.g., volatile and/or non-volatile memory). The volatile memory 316 can include one or a plurality of memory modules (e.g., chips).

The processor resources 314 can be connected to a bus 326 to provide for communication between the processor resources 314, and other portions of the system 300. The non-volatile memory 318 can provide persistent data storage for the system 300. The graphics controller 328 can connect to a user interface 330, which can provide an image to a user based on activities performed by the system 300.

Each system can include a computing device including control circuitry such as a processor, a state machine, application specific integrated circuit (ASIC), controller, and/or similar machine. As used herein, the indefinite articles “a” and/or “an” can indicate one or more than one of the named object. Thus, for example, “a processor” can include one processor or more than one processor, such as a parallel processing arrangement.

The control circuitry can have a structure that provides a given functionality, and/or execute computer-readable instructions that are stored on a non-transitory computer-readable medium (e.g. non-transitory computer-readable medium 320). The non-transitory computer-readable medium can be integral, or communicatively coupled, to a computing device, in either in a wired or wireless manner. For example, the non-transitory computer-readable medium 320 can be an internal memory, a portable memory, a portable disk, or a memory located internal to another computing resource (e.g., enabling the computer-readable instructions to be downloaded over the Internet). The non-transitory computer-readable medium 320 can have computer-readable instructions 315 stored thereon that are executed by the control circuitry (e.g., processor) to provide a particular functionality.

The non-transitory computer-readable medium, as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, EEPROM, phase change random access memory (PCRAM), among others. The non-transitory computer-readable medium can include optical discs, digital video discs (DVD), Blu-Ray Discs, compact discs (CD), laser discs, and magnetic media such as tape drives, floppy discs, and hard drives, solid state media such as flash memory, EEPROM, phase change random access memory (PCRAM), as well as other types of computer-readable media.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A computer-implemented method for designing warranty bonuses comprising:
determining, for a customer base of a product, a first probability that a customer will replace the product with a different product;
determining, for the customer base, a marginal contribution to the first probability for a plurality of warranty bonus sizes and a plurality of warranty bonus types;
determining, for the customer base, a second probability that the customer will purchase a warranty for the plurality of warranty bonus sizes and the plurality of warranty bonus types;
bundling the product and the warranty; and
assigning a number of the plurality of warranty bonus sizes and a number of the plurality of warranty bonus types to the product-warranty bundle based on the first and second probabilities and the marginal contribution.

2. The method of claim 1 wherein assigning the number of the plurality of warranty bonus sizes and the number of the plurality of warranty bonus types includes assigning multiple bonus sizes and multiple bonus types.

3. The method of claim I wherein assigning the number of the plurality of warranty bonus sizes and the number of the plurality of warranty bonus types includes assigning the number of warranty bonus sizes and the number of warranty bonus types so that a function of short- and long-term profits reaches or exceeds a total profit threshold for an overall combination of short-term profits and long-term profits.

4. The method of claim 3 wherein the short-term profits are based on a function of warranty price and probability of warranty purchase, and the long-term profits are based on a function of a probability of warranty purchase, a probability of repurchase and expected margins on future sales of a plurality of products.

5. The method of claim 3 wherein the method includes assigning a first relative weight to short-term profits and a second relative weight to long-term profits based on the importance of the short-term and long-term profits to the warranty provider.

6. The method of claim 1 wherein the method includes determining a margin earned for each of a plurality of products sold from a specific category and a support cost for a warranty of a specific length on the product.

7. The method of claim 1 wherein the method includes determining the first and second probabilities and the marginal contribution for the customer base of each of a plurality of products.

8. The method of claim 1 wherein the method includes determining the customer base using at least one of determining the specific population segment the product was designed for and dynamically collecting customer purchasing information from surveys and product registration data analysis.

9. The method of claim 8 wherein product registration data analysis includes analyzing at least one of the customer's age, the customer's income, the product purchased, date of purchase, location of purchase, purchase influencers, and the purchase price.

10. A computer-readable non-transitory medium storing a set of instructions for designing warranty bonuses executable by the computer to cause the computer to:
determine, for a customer base of each of a plurality of products, a first probability that a customer will replace one of the plurality of products with a different product in a specific category at a specific time;
determine, for the customer base, a marginal contribution to the first probability for each of a plurality of warranty bonus sizes and each of a plurality of warranty bonus types;
determine, for the customer base, a second probability that the customer will purchase a warranty of a specific length and a specific price for each of a plurality of warranty refund types and each of a plurality of warranty refund sizes;
receive a total profit threshold based on desired overall short-term profits and desired overall long-term profits;
receive the specific price and the specific length;
bundle the one of the plurality of products and the warranty of the specific length and the specific price; and
assign a number of the plurality of warranty bonus sizes, a number of the plurality of warranty bonus types, and a number of the plurality of warranty prices to the product-warranty bundle so that a function of the short-term profits and the long-term profits reaches or exceeds the total product threshold given the first and second probabilities, the marginal contribution, the specific price, and the specific length.

11. The medium of claim 10 wherein the number of the plurality of warranty bonus sizes and the number of the plurality of bonus types are assigned to the product-warranty bundle so that a function of the short- and long-term profits reaches a highest overall total product threshold.

12. The medium of claim 11 wherein the function of short- and long-term profits includes:
a relative weight of short-term profits;
a relative weight of long-term profits;
the first probability;
the second probability;
the marginal contribution;
a margin earned per product sold from the specific category;
a support cost for the warranty;
possible refund types; and
possible refund sizes.

13. A system for designing warranty bonuses, comprising:
a computing device including:
a memory;
a processor coupled to the memory, to:
determine, for a customer base of a product, a first probability that a customer will replace the product with a different product in a specific category at a specific time when the customer receives a warranty of a specific length without a bonus;
determine, for the customer base, a second probability that the customer will replace the product with the different product when the customer receives a warranty of a specific length with a bonus of a specific type and a specific size;
determine, for the customer base, a marginal contribution to the first and second probabilities of each of a plurality of warranty bonus sizes and each of a plurality of warranty bonus types;
determine, for the customer base, a third probability that the customer will purchase a warranty of a specific length with a specific refund type and a specific refund size at a specific price;
bundle the product and the warranty of a specific length; and
assign a number of the plurality of warranty bonus sizes and a number of the plurality of warranty bonus types to the product-warranty bundle based on a plurality of variables including the first, second, and third probabilities; the marginal contributions; a weight of short-term and long-term profits; a margin earned per product sold from the specific category; and a support cost for a warranty of a specific length on the product.

14. The system of claim 13 wherein the specific warranty price is zero.

15. The system of claim 13 wherein the warranty bonus type includes at least one of cash, check, and coupon toward a future purchase.
